(19) United States
(12) Patent Application Publication
(10) Pub. No.: US 2014/0247480 A1
(43) Pub. Date: Sep. 4, 2014

(54) GLASS MEMBER WITH OPTICAL MULTILAYERED NEAR INFRARED CUT FILTER GLASS

(71) Applicant: ASAHI GLASS COMPANY, LIMITED, Chiyoda-ku (JP)

(72) Inventors: Mitsuyuki Tatemura, Haibara-gun (JP); Kazuhiro Tamai, Haibara-gun (JP); Takashi Nagata, Haibara-gun (JP); Katsushi Kamijyo, Haibara-gun (JP)

(73) Assignee: ASAHI GLASS COMPANY, LIMITED, Chiyoda-ku (JP)

(21) Appl. No.: 14/227,487

(22) Filed: Mar. 27, 2014

Related U.S. Application Data
(63) Continuation of application No. PCT/JP2012/080228, filed on Nov. 21, 2012.

(30) Foreign Application Priority Data
Nov. 21, 2011 (JP) 2011-253916

(51) Int. Cl. G02B 5/28

(52) U.S. Cl. CPC G02B 5/282
USPC 359/359

(57) ABSTRACT

To provide a glass member with an optical multilayer from which film separation of the optical multilayer is suppressed, and a near infrared cut filter glass.

A glass member with an optical multilayer, comprising a fluorophosphate glass substrate and an optical multilayer formed on the substrate, wherein an adhesion-strengthening layer consisting of one or more layers, which improves the adhesion of the optical multilayer to the fluorophosphate glass substrate, is formed between the fluorophosphate glass substrate and the optical multilayer; and the optical multilayer is formed by a sputtering method or an ion-beam assisted deposition method, and the adhesion-strengthening layer is formed by a deposition method without using ion-beam assist.

### TECHNICAL FIELD

The present invention relates to a glass member with an optical multilayer utilized as a visibility correction filter of a solid-state imaging element such as a CCD or a CMOS utilized for a digital still camera, a video camera, etc.

### BACKGROUND ART

The spectral sensitivity of a solid-state imaging element such as a CCD or a CMOS utilized for a digital still camera or a video camera is characterized to be highly intense to light in the near infrared region as compared with the sensitivity of a human. Therefore, usually, a sensitivity correction filter is used to adapt the spectral sensitivity of such a solid-state imaging element to the visibility of a human.

As such a visibility correction filter, Patent Document 1 discloses a near infrared cut filter glass having spectral properties adjusted by the presence of Cu²⁺ ions in glass such as fluorophosphate glass or phosphate glass (Patent Document 1).

Further, for the purpose of accurately and sharply determining the wavelength region the light in which is transmitted, a near infrared cut filter glass has been known which has an optical multilayer consisting of high refractive index layers and low refractive index layers alternately laminated, on the surface of the above near infrared cut filter glass, whereby light having a wavelength in the visible region (from 400 to 600 nm) is efficiently transmitted, and an excellent sharp cut property to light having a wavelength (700 nm) in the near infrared region is achieved (Patent Document 2). In addition, for the purpose of suppressing reflection on the glass substrate surface and improving the transmittance, an antireflection film is provided in some cases on the surface of the near infrared cut filter glass.

The optical multilayer consists of, in the case of a near infrared cut filter, for example, a high refractive index layer made of titanium oxide, tantalum oxide, niobium oxide or the like and a low refractive index layer made of silicon oxide or the like alternately laminated on a glass substrate, and selectively transmits light utilizing interference of light by properly adjusting the thickness and the number of layers of the high refractive index layer and the low refractive index layer.

### PRIOR ART DOCUMENTS

### Patent Documents

Patent Document 1: JP-A-06-16451
Patent Document 2: JP-A-02-213803

### DISCLOSURE OF INVENTION

### Technical Problem

An optical multilayer to be used for a near infrared cut filter glass is required to have higher hardness so as to increase the abrasion resistance in production steps e.g. against contact with other members at the time of transport or assembling of a glass member. Further, it is required to be a so-called non-shift film, of which the change in spectral properties e.g. by humidity during long term storage is small. Further, as a method for forming such an optical multilayer having high hardness and high weather resistance, a film deposition method by a sputtering method or an ion-beam assisted deposition method (IAD, deposition method using ion-beam assist) has been known.

However, in a case where an optical multilayer is formed on the glass substrate surface of fluorophosphate glass by means of a film deposition method such as a sputtering method or an ion-beam assisted deposition method, adhesion between the glass substrate and the optical multilayer is not sufficient, and film separation is likely to occur when the glass substrate is cut into small pieces.

As the reason, the following are mentioned.

Fluorophosphate glass contains fluorine components in the glass composition, and fluorine having a low surface free energy is present on the glass surface, and accordingly the fluorophosphate glass has poor adhesion to other substances.

On the other hand, an optical multilayer formed by a sputtering method or an ion-beam assisted deposition method is very densely constituted by film substances and thereby has high hardness.

In a case where an optical multilayer having high hardness is formed on the surface of the above-described glass substrate having poor adhesion to an optical multilayer, it is considered that the contact state between the glass substrate and the optical multilayer is weakened by impact at the moment when the optical multilayer is cut, whereby the phenomenon that the optical multilayer is separated from the glass substrate occurs.

Under these circumstances, the object of the present invention is to provide a glass member with an optical multilayer from which separation of the optical multilayer is suppressed, and a near infrared cut filter glass.

### Solution to Problem

The present invention provides a glass member with an optical multilayer, comprising a fluorophosphate glass substrate and an optical multilayer formed on the substrate, wherein an adhesion-strengthening layer consisting of one or more layers, which improves the adhesion of the optical multilayer to the fluorophosphate glass substrate, is formed between the fluorophosphate glass substrate and the optical multilayer; and the optical multilayer is formed by a sputtering method or an ion-beam assisted deposition method, and the adhesion-strengthening layer is formed by a deposition method without using ion-beam assist (hereinafter sometimes referred as a glass member with an optical multilayer of the present invention).

The present invention further provides the glass member with an optical multilayer of the present invention, wherein the adhesion-strengthening layer has an oxide film made of a material selected from silicon oxide (SiO₂), titanium oxide (TiO₂), lanthanum titanium oxide (La₂Ti₂O₇), aluminum oxide (Al₂O₃), and a mixture of aluminum oxide (Al₂O₃) and zirconium oxide (ZrO₂), as a first layer on the fluorophosphate glass substrate side.

The present invention further provides the glass member with an optical multilayer of the present invention, wherein the adhesion-strengthening layer has an oxide film having a refractive index of at most 1.68, as a first layer on the fluorophosphate glass substrate side.

The present invention further provides the glass member with an optical multilayer of the present invention, wherein the adhesion-strengthening layer has, in addition to the oxide film, a magnesium fluoride (MgF₂) film as a layer other than the first layer on the fluorophosphate glass substrate side.

The present invention further provides the glass member with an optical multilayer of the present invention, wherein the adhesion-strengthening layer has a three-layer structure having a film of a mixture of aluminum oxide (Al₂O₃) and zirconium oxide (ZrO₂), a zirconium oxide (ZrO₂) film and a magnesium fluoride (MgF₂) film laminated in this order from the glass substrate side.

The present invention further provides the glass member with an optical multilayer of the present invention, wherein the optical multilayer consists of 15 or more layers, or has a total thickness of at least 1 μm.

The present invention further provides the glass member with an optical multilayer of the present invention, wherein the adhesion-strengthening layer has substantially no influence over optical properties of the optical multilayer.

The present invention further provides the glass member with an optical multilayer of the present invention, wherein the adhesion-strengthening layer constitutes a part of the optical multilayer.

The present invention further provides the glass member with an optical multilayer of the present invention, wherein the optical multilayer is at least one member of an antireflection film, an infrared-shielding film, an ultraviolet-shielding film and an ultraviolet- and infrared-shielding film.

The present invention further provides the glass member with an optical multilayer of the present invention, wherein the first layer of the adhesion-strengthening layer on the fluorophosphate glass substrate side contains an Al component, and the fluorophosphate glass substrate contains as essential components P⁵⁺, Al³⁺, F⁻ and Cu²⁺.

The present invention still further provides a near infrared cut filter glass, comprising the glass member with an optical multilayer of the present invention.

### Advantageous Effects of Invention

According to the present invention, a glass member with an optical multilayer from which separation of the optical multilayer is suppressed by forming the optical multilayer on the main surface of a glass substrate via an adhesion-strengthening layer, and a near infrared cut filter glass, are provided.

### BRIEF DESCRIPTION OF DRAWINGS

FIG. 1 is a view schematically illustrating the structure of a glass member with an optical multilayer according to an embodiment of the present invention.

FIG. 2 is a view schematically illustrating the structure of a glass member with an optical multilayer according to another embodiment of the present invention.

### DESCRIPTION OF EMBODIMENTS

Now, the present invention will be described with reference to drawings.

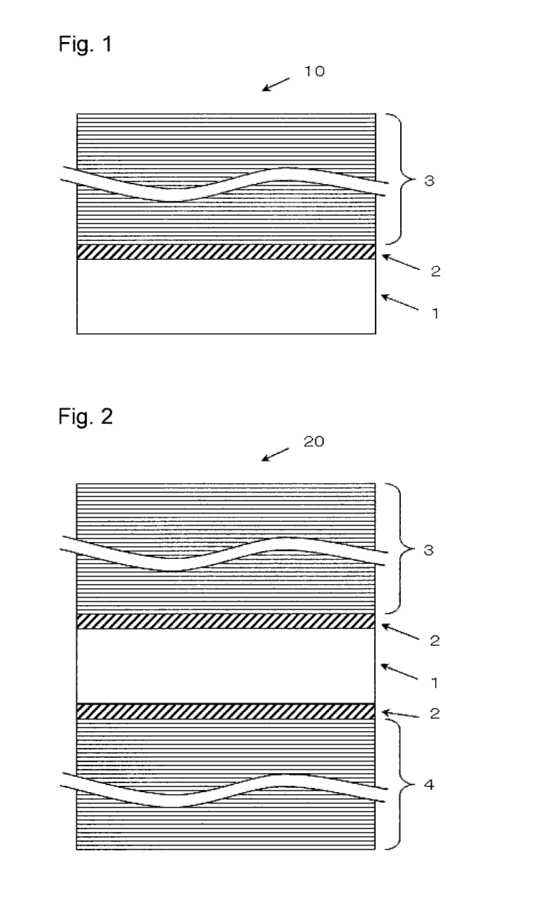

FIG. 1 is a drawing schematically illustrating the structure of a glass member 10 with an optical multilayer according to an embodiment of the present invention. The glass member 10 with an optical multilayer shown in FIG. 1 comprises a glass substrate 1, an adhesion-strengthening layer 2 formed on the main surface of the glass substrate 1, and an optical multilayer 3 formed on the adhesion-strengthening layer 2. From the glass member 10 with an optical multilayer, film separation is suppressed by the adhesion-strengthening layer 2 interposed between the fluorophosphate glass substrate 1 and the optical multilayer 3, which improves the adhesion between them.

The optical multilayer 3 is properly selected depending upon the purpose of use, and for example, an antireflection film (AR film) having an antireflection function, an infrared-shielding film, an ultraviolet-shielding film, or an ultraviolet- and infrared-shielding film may be mentioned. Further, it may also be one having functions of both of the antireflection film and the infrared-shielding film. As the optical multilayer 3 having such a function, for example, a laminate film having a low refractive index film and a high refractive index film alternately disposed may be used. The low refractive index film may, for example, be a silicon oxide film. The high refractive index film may, for example, be a metal oxide film made of at least one member selected from niobium oxide, titanium oxide and tantalum oxide.

The optical multilayer 3 is formed by a sputtering method or an ion-beam assisted deposition method. A film formed by a sputtering method or an ion-beam assisted deposition method is advantageous in that the change in its spectral properties at high temperature under high humidity is very small as compared with a film formed by a deposition method without using ion-beam assist, whereby a non-shift film with substantially no spectral change can be realized. Further, a film formed by such a method is hardly scared due to high hardness, and is also excellent in handling efficiency e.g. in a member assembling step. Accordingly, such a method is suitable as a method of forming an optical multilayer for a near infrared cut filter glass to be used as a sensitivity correction filter of a solid-state imaging element.

Of the optical multilayer 3, the thicknesses and the number of lamination of the low refractive index film and the high refractive index film are properly set depending upon the optical properties required. Film separation between the glass substrate 1 and the optical multilayer 3 is likely to occur when the total thickness of the optical multilayer 3 is thicker or the number of layers is larger. Accordingly, the adhesion-strengthening layer 2 can more effectively suppress film separation when the optical multilayer 3 consists of 15 or more layers or has a total thickness of at least 1 μm.

As the glass substrate 1, fluorophosphate glass is used. The fluorophosphate glass preferably contains glass matrix having a total content of components, as represented by mass % based on the following oxides or fluorides, from 10 to 60% of P₂O₅, from 0 to 20% of AlF₃, from 1 to 30% of LiF+NaF+KF and from 10 to 75% of MgF₂+CaF₂+SrF₂+BaF₂ (provided that up to 70% of the total amount of fluorides can be substituted by oxides), and from 0.5 to 12 parts by mass of CuO by outer percentage per 100 parts by mass of the glass matrix.

In this specification, “to” used to show the range of the numerical values is used to include the numerical values before and after it as the lower limit value and the upper limit value, and unless otherwise specified, the same applies hereinafter.

In a case where the adhesion-strengthening layer 2 formed as a first layer on the glass substrate side contains an Al component, the glass substrate 1 is preferably fluorophosphate glass containing as essential components P⁵⁺, Al³⁺, F⁻ and Cu²⁺.

It was found that the adhesion between the adhesion-strengthening layer 2 and the glass substrate 1 is particularly excellent in a case where both the adhesion-strengthening layer 2 and the glass substrate 1 contain an Al component. This is considered to be because the adhesion-strengthening layer 2 and the glass substrate 1 contain the same component, the physical or chemical bonding strength at the interface between the adhesion-strengthening layer 2 and the glass substrate 1 is increased. As the adhesion-strengthening layer 2 containing an Al component, a film made of aluminum oxide (Al₂O₃) or a mixture of aluminum oxide (Al₂O₃) and zirconium oxide (ZrO₂) may be mentioned as a typical example.

The glass substrate 1 is preferably made of fluorophosphate glass containing, as represented by cation % from 20 to 55% of P⁵⁺, from 1 to 25% of Al³⁺, from 1 to 50% of R⁺ (wherein R⁺ is alkali metal ions of Li⁺, Na⁺ and K⁺, and the content as R⁺ represents the total content of alkali metal ions contained), from 1 to 50% of R²⁺ (wherein R²⁺ is alkaline earth metal ions of Mg²⁺, Ca²⁺, Sr²⁺, Ba²⁺ and Zn²⁺, and the content as R²⁺ represents the total content of the alkaline earth metal ions contained), from 1 to 10% of Cu²⁺ and from 0 to 3% of Sb³⁺, and containing, as represented by anion %, from 35 to 95% of O²⁻ and from 5 to 65% of F⁻.

Further, as R⁺ contained in the glass substrate 1, as represented by cation %, from 0 to 40% of Li⁺, from 0 to 40% of Na⁺ and from 0 to 40% of K⁺ are preferably contained.

Further, as R²⁺ contained in the glass substrate 1, as represented by cation %, from 0 to 20% of Mg²⁺, from 0 to 40% of Ca²⁺, from 0 to 40% of Sr²⁺, from 0 to 40% of Ba²⁺, and from 0 to 40% of Zn²⁺ are preferably contained.

Now, the reason why the contents (as represented by cation % and anion %) of the respective components constituting the glass substrate 1 are limited as above, is described below.

P⁵⁺ is a main component forming glass (i.e. a glass-forming oxide), and is an essential component to increase the near infrared cutting performance. However, if its content is less than 20%, no sufficient effect will be obtained, and if it exceeds 55%, the viscosity of the glass tends to be high, the liquid phase temperature of the glass tends to be high, or the weather resistance tends to be low. It is preferably from 25 to 50%, more preferably from 30 to 45%.

Al³⁺ is a main component to form glass (i.e. a glass-forming oxide), and is an essential component to increase the adhesion to the adhesion-strengthening layer containing an Al component. However, if its content is less than 1%, no sufficient effect will be obtained, and the weather resistance tends to be low, and if it exceeds 25%, the glass tends to be unstable, or the infrared cutting performance tends to be low. It is preferably from 3 to 20%, more preferably from 5 to 18%, further preferably from 7 to 16%.

R⁺ is an essential component to lower the glass melting temperature, to lower the glass liquid phase temperature, to soften the glass and to stabilize the glass. However, if its content is less than 1%, no sufficient effect will be obtained, and if it exceeds 50%, the glass tends to be unstable. It is preferably from 5 to 40%, more preferably from 10 to 35%, further preferably from 15 to 30%.

Li⁺ has effects to lower the glass melting temperature, to lower the glass liquid phase temperature, to soften the glass and to stabilize the glass. However, if its content exceeds 40%, the glass tends to be unstable. It is preferably from 1 to 35%, more preferably from 5 to 32%, further preferably from 10 to 29%.

Na⁺ has effects to lower the glass melting temperature, to lower the glass liquid phase temperature, to soften the glass and to stabilize the glass. However, if its content exceeds 40%, the glass tends to be unstable. It is preferably from 1 to 35%, more preferably from 5 to 32%, further preferably from 10 to 29%.

K⁺ has effects to lower the glass melting temperature, to lower the glass liquid phase temperature, to soften the glass and to stabilize the glass. However, if its content exceeds 40%, the glass tends to be unstable. It is preferably from 1 to 35%, more preferably from 5 to 32%, further preferably from 10 to 29%.

R²⁺ is an essential component to lower the glass melting temperature, to lower the glass liquid phase temperature, to soften the glass and to stabilize the glass. However, if its content is less than 1%, no sufficient effect will be obtained, and if it exceeds 50%, the glass tends to be unstable. It is preferably from 5 to 40%, more preferably from 10 to 35%, further preferably from 15 to 30%.

Mg²⁺ has effects to lower the glass melting temperature, to lower the glass liquid phase temperature, to soften the glass and to stabilize the glass. However, if its content exceeds 20%, the glass tends to be unstable. It is preferably from 1 to 15%, more preferably from 2 to 10%, further preferably from 3 to 5%.

Ca²⁺ has effects to lower the glass melting temperature, to lower the glass liquid phase temperature, to soften the glass and to stabilize the glass. However, if its content exceeds 40%, the glass tends to be unstable. It is preferably from 1 to 30%, more preferably from 2 to 20%, further preferably from 3 to 10%.

Sr²⁺ has effects to lower the glass melting temperature, to lower the glass liquid phase temperature, to soften the glass and to stabilize the glass. However, if its content exceeds 40%, the glass tends to be unstable. It is preferably from 1 to 30%, more preferably from 2 to 20%, further preferably from 3 to 10%.

Ba²⁺ has effects to lower the glass melting temperature, to lower the glass liquid phase temperature, to soften the glass and to stabilize the glass. However, if its content exceeds 40%, the glass tends to be unstable. It is preferably from 1 to 30%, more preferably from 2 to 20%, further preferably from 3 to 10%.

Zn²⁺ has effects to lower the glass melting temperature, to lower the glass liquid phase temperature, to soften the glass and to stabilize the glass. However, if its content exceeds 40%, the glass tends to be unstable. It is preferably from 1 to 30%, more preferably from 2 to 20%, further preferably from 3 to 10%.

Cu²⁺ is an essential component for near infrared cutting, however, if its content is less than 1%, no sufficient effect will be obtained, and if it exceeds 10%, the visible transmittance tends to be decreased. It is preferably from 2 to 8%, more preferably from 3 to 7%.

Sb³⁺ is not an essential component but has an effect to decrease the redox of copper and to increase the visible transmittance. However, if its content exceeds 3%, the stability of the glass tends to be decreased. It is preferably from 0 to 2%, more preferably from 0.01 to 1%, further preferably from 0.05 to 0.5%.

O²⁻ is an essential component to stabilize the glass. However, if its content is less than 35%, no sufficient effect will be obtained, and if it exceeds 95%, the glass tends to be unstable. It is preferably from 55 to 90%, more preferably from 60 to 85%.

F⁻ is an essential component to stabilize the glass and to improve the weather resistance. However, if its content is less than 5%, no sufficient effects will be obtained, and if it exceeds 65%, the visible transmittance will be decreased. It is preferably from 10 to 45%, more preferably from 15 to 40%.

The glass substrate 1 preferably contains substantially no PbO or As₂O₃. PbO is a component to lower the viscosity of the glass and to improve the production workability. Further, As₂O₃ is a component which acts as a fining agent or an oxidizing agent. However, as PbO and As₂O₃ are environmental load substances, they are preferably not contained as far as possible. Here, “containing substantially no” means that such components are not intentionally used as raw materials, and inevitable impurities included from the raw material components or in the production step are considered to be not substantially contained. Further, “containing substantially no component” means its content of at most 0.1% considering inevitable impurities.

The glass substrate 1 is formed as follows. Glass raw materials are blended so as to achieve the above-described desired glass composition, melted, and the molten glass is formed. The outer shape is processed into a desired size to prepare a glass substrate, and the glass surface of the glass substrate is lapped and polished. Then, an optical multilayer and an adhesion-strengthening layer are formed on the glass substrate, and a glass member with an optical multilayer is cut by a known method (e.g. scribing, dicing or laser cutting) into a predetermined product size.

The fluorophosphate glass having the above composition is excellent in the weather resistance, and by the glass containing CuO, spectral properties suitable for a near infrared cut filter glass can be obtained. Further, as the fluorophosphate glass, for example, glass having a composition within a range or glass disclosed in Examples in JP-A-3-83834, JP-A-6-16451, JP-A-8-253341, JP-A-2004-83290 or JP-A-2011-132077 may be used.

The fluorophosphate glass contains a fluorine component as a glass component. Accordingly, the fluorine component present on the glass surface is considered to decrease the adhesion of the optical multilayer 3 formed on the glass surface. Further, as described above, a film formed by a sputtering method or an ion-beam assisted deposition method has high hardness as compared with a film formed by a deposition method without using ion-beam assist. Since the fluorophosphate glass has low hardness and high fragility (i.e. is highly fragile) as compared with silicate glass, it is likely to be broken and scared when an external force is applied. Therefore, if a glass member with an optical multilayer having high film hardness formed on the surface of fluorophosphate glass having low hardness is cut, it is considered that a stress is concentrated on the interface between the glass substrate and the optical multilayer with a large difference in hardness, and the breakage extends, whereby the adhesion between them is weakened.

Here, the ion-beam assisted deposition method is a method to obtain a dense film or to increase the adhesion of a coating film by the high kinetic energy of ions during film deposition by a vacuum deposition method, and for example, an ion beam deposition method or an ion plating deposition method has been known. For example, the method by ion beam is a method of accelerating the material to be deposited by ionized gas molecules emitted from an ion gun to form a film on the substrate surface. Whereas, the deposition method without using ion-beam assist is a method without using the above-mentioned ion beam or ion plating.

In the glass member with an optical multilayer of the present invention, the adhesion-strengthening layer 2 is interposed between the glass substrate 1 and the optical multilayer 3 to improve the adhesion between them and to suppress film separation, and is formed by a deposition method without using ion-beam assist. The adhesion-strengthening layer 2, which is formed by a deposition method without using ion-beam assist, has low hardness and is highly fragile. Thus, the physical properties of the glass substrate 1 are close to those of the adhesion-strengthening layer 2, and the point where the stress is concentrated when the glass member 10 is cut is shifted from the interface between the glass substrate and the optical multilayer to the interface between the adhesion-strengthening layer 2 and the optical multilayer 3. The adhesion-strengthening layer 2 and the optical multilayer 3 are different from each other in the hardness but are similar to each other in the production method, etc., and accordingly they are hardly separated from each other. Further, when the glass member 10 is cut in the thickness direction, it is considered that the highly fragile adhesion-strengthening layer 2 is broken first, whereby the stress is absorbed and as a result, scars which cause film separation will not extend. Accordingly, in the glass member 10 with an optical multilayer of the present invention, the adhesion-strengthening layer 2, which is interposed between the glass substrate 1 and the optical multilayer 3, is considered to improve the adhesion between them and to suppress film separation.

The adhesion-strengthening layer 2 is a film having low hardness and being highly fragile. As described above, the adhesion-strengthening layer 2 has such properties since it is formed by a deposition method without using ion-beam assist. In order to obtain a film having a further lower hardness and being more fragile by a deposition method, it is preferred to adjust the temperature of the glass substrate 1 when the adhesion-strengthening layer 2 is formed, to a temperature lower than that employed in a conventional deposition method. Specifically, in a case where a thin film is to be formed on the fluorophosphate glass substrate by means of a deposition method without using ion-beam assist, usually, the temperature of the glass substrate is at a level of from 200° C. to 350° C. Whereas, in the present invention, it is preferred to form the adhesion-strengthening layer 2 at a temperature of the glass substrate at the time of film deposition of from 120° C. to 200° C. (not including 200° C.), more preferably from 120° C. to 160° C. Further, by the temperature of the glass substrate within the above range, the difference between the temperature of the glass substrate 1 when the adhesion-strengthening layer 2 is formed and the temperature of the glass substrate 1 when the optical multilayer 3 is formed by the ion-beam assisted deposition method becomes smaller. Accordingly, it is possible to form them continuously, thus increasing the productivity. This is because in the ion-beam assisted deposition method, as the energy by the ion-beam assist is added, the glass substrate temperature is preferably lower by several tens ° C. than the glass substrate temperature in the deposition method without using ion-beam assist.

Further, as another method to obtain a film having a further lower harness and being more fragile by the deposition method, the degree of vacuum in the deposition apparatus is adjusted to be a degree of vacuum lower than that employed in a conventional deposition method. Specifically, when the adhesion-strengthening layer 2 is to be formed, it is preferred to carry out film deposition by introducing at least 10 sccm of an inert gas (such as an argon gas) or a reactive gas (such as an oxygen gas).

The adhesion-strengthening layer 2 preferably has an oxide film made of a material selected from silicon oxide (SiO₂), titanium oxide (TiO₂), lanthanum titanium oxide (La₂Ti₂O₇), aluminum oxide (Al₂O₃) and a mixture of aluminum oxide (Al₂O₃) and zirconium oxide (ZrO₂), as a first layer on the glass substrate side. Further, the adhesion-strengthening layer 2 is preferably formed by a deposition method while its film properties are adjusted by controlling the degree of vacuum during film deposition. In such a manner, an adhesion-strengthening layer 2 having low hardness and high fragility can be obtained.

The adhesion-strengthening layer 2 preferably has an oxide film having a refractive index of at most 1.70, preferably at most 1.68 as a first layer on the glass substrate side. The adhesion-strengthening layer formed as a first layer on the glass substrate side is one formed immediately after the film deposition step on the glass substrate surface is started. When the film deposition step is started, the state in the deposition apparatus etc. are not stabilized, and the state (for example, refractive index) of the film to be formed may not achieve the desired properties. By the oxide film as the first layer on the glass substrate side having a refractive index of at most 1.68, the difference with the refractive index (for example, 1.52) of the glass substrate 1 tends to be small. Thus, even if the state of the adhesion-strengthening layer 2 is somewhat out of the range of the desired properties resulting from the above-described film deposition step, the influence over the spectral properties of the glass member can be negligibly small. The oxide film having a refractive index of at most 1.68 may be a film of silicon oxide (SiO₂, refractive index: 1.46), aluminum oxide (Al₂O₃, refractive index: 1.64) or a mixture (refractive index: 1.67) of aluminum oxide (Al₂O₃) and zirconium oxide (ZrO₂). Here, the refractive index of the adhesion-strengthening layer 2 in the present invention is the refractive index at a wavelength of 500 nm.

The adhesion-strengthening layer 2 may consists of a single layer or a plurality of layers, so long as it has the above-described oxide film as the first layer on the glass substrate side. In a case where the adhesion-strengthening layer 2 consists of a plurality of layers, it preferably has a magnesium fluoride (MgF₂) film as a layer other than the first layer on the glass substrate side, in addition to the oxide film. Since the magnesium fluoride (MgF₂) film is a very fragile film, by constituting the adhesion-strengthening layer 2 in combination with the oxide film, the adhesion between the glass substrate 1 and the optical multilayer 3 is improved, and film separation can be suppressed. Further, by using the oxide film and the magnesium fluoride (MgF₂) film in combination, it is possible to make the oxide film thin as compared with use of the oxide film by itself, thus improving the productivity.

The adhesion-strengthening layer 2 more preferably has a three-layer structure having a film of a mixture of aluminum oxide (Al₂O₃) and zirconium oxide (ZrO₂), a zirconium oxide (ZrO₂) film and a magnesium fluoride (MgF₂) film from the glass substrate side. By such a film structure, the adhesion-strengthening layer 2 has a high antireflection function. Therefore, the adhesion-strengthening layer 2 can be constituted without influences over the optical properties of the optical multilayer 3. Further, a film of a mixture of aluminum oxide (Al₂O₃) and zirconium oxide (ZrO₂) can form a film having low hardness and high fragility, and thereby contributes to adhesion between the glass substrate and the optical multilayer, and separation of them at the time of cutting the glass member can be suppressed. Further, in a case where the adhesion-strengthening layer 2 is constituted by a plurality of layers, an alternate layer with silicon oxide (SiO₂) and titanium oxide (TiO₂) may also be suitably used.

The adhesion-strengthening layer 2 preferably has substantially no influence over optical properties of the optical multilayer 3, whereby even when the adhesion-strengthening layer 2 and the optical multilayer 3 are separately designed, the adhesion-strengthening layer 2 will not influence the spectral properties of the glass member with an optical multilayer. The thickness of the adhesion-strengthening layer 2 is preferably at most 1 μm, more preferably at most 500 nm considering the productivity and the spectral properties. Further, the thickness of the adhesion-strengthening layer 2 is preferably at least 50 nm, more preferably at least 100 nm, since if it is too thin, the adhesion between the optical multilayer 3 and the glass substrate 1 will not be obtained. Further, “having substantially no influence” means that when the adhesion-strengthening layer 2 and the optical multilayer 3 are separately designed, the spectral properties of both of the adhesion-strengthening layer 2 and the optical multilayer 3 and the spectral properties of the optical multilayer 3 alone are not significantly different from each other.

Otherwise, the adhesion-strengthening layer 2 may constitute a part of the optical multilayer 3, whereby it is not necessary to consider the influences of the adhesion-strengthening layer 2 over the optical properties. For example, at least a film of the optical multilayer 3 to be in contact with the glass substrate 1 is formed by a deposition method without using ion-beam assist, and subsequent films of the optical multilayer 3 are formed by the ion-beam assisted deposition method. In such a case, the optical multilayer 3 formed by the deposition method without using ion-beam assist, constituting a part of the optical multilayer 3, functions as the adhesion-strengthening layer 2 also, and contributes to an improvement in the adhesion between the glass substrate 1 and the optical multilayer 3. Further, some layers of the optical multilayer 3 which function as the adhesion-strengthening layer 2 may be formed by the deposition method without using ion-beam assist, and then the remaining layers of the optical multilayer 3 are formed by a sputtering method.

Now, another embodiment of the present invention is shown in FIG. 2. This embodiment is different from the above-described embodiment in that adhesion-strengthening layers and optical multilayers are formed on both sides of the glass substrate.

A glass member 20 with an optical multilayer according to this embodiment has optical multilayers 3 and 4 having the following function on each surface of the glass substrate 1, and has an adhesion-strengthening layer 2 between the glass substrate 1 and each of the optical multilayers 3 and 4. Specific examples of the structure according to this embodiment include antireflection film/adhesion-strengthening layer/glass substrate/adhesion-strengthening layer/antireflection film, antireflection film/adhesion-strengthening layer/glass substrate/adhesion-strengthening layer/infrared-shielding film, infrared-shielding film/adhesion-strengthening layer/glass substrate/adhesion-strengthening layer/infrared-shielding film, and infrared-shielding film/adhesion-strengthening layer/glass substrate/adhesion-strengthening layer/ultraviolet- and infrared-shielding film.

In a case where the glass member 20 with an optical multilayer is used as a near infrared cut filter, a filter which suppresses the change in spectral properties depending on the light incident angle as far as possible is required. In such a case, for example, as the glass member 20 with an optical multilayer, a structure of infrared-shielding film/adhesion-strengthening layer/glass substrate/adhesion-strengthening layer/ultraviolet- and infrared-shielding film is employed. Since the infrared-shielding film and the ultraviolet- and infrared-shielding film has a large number of layers and has a thick total thickness, it is necessary to provide an adhesion-strengthening layer at the interface between the glass substrate and each optical multilayer.

In a case where optical multilayers are formed on both sides of the glass substrate, and when one of the optical multilayers has a small total thickness or number of layers and accordingly film separation is less likely to occur, the adhesion-strengthening layer may not be formed for the one of the optical multilayers.

Now, the present invention will be described in further detail with reference to Examples. However, it should be understood that the present invention is by no means restricted to the following Examples, and various changes and modifications are possible within the intention and the scope of the present invention.

### EXAMPLES

As a glass member with an optical multilayer in each of Examples and Comparative Example, the following glass substrate and optical multilayer were used. As the glass substrate, plate-form fluorophosphate glass (tradename: NF-50, manufactured by AGC TECHNO GLASS CO., LTD., size: 50 mm×50 mm, thickness: 0.05 mm) having its main surface precisely polished was used. As the optical multilayer, an infrared-shielding film (an alternate film having three-layer basic layers each having a titanium oxide (TiO₂) film, a silicon oxide (SiO₂) film and a tantalum oxide (Ta₂O₅) layer laminated in this order, repeatedly laminated (the number of the three-layer basic layers: 80 layers, total thickness: 4 μm)) was formed on one main surface of the glass substrate by an ion-beam assisted deposition method. The temperature of the glass substrate was 128° C. at the time when the optical multilayer was formed on the glass substrate by the ion-beam assisted deposition method. Further, in each Example, the following adhesion-strengthening layer was provided between the glass substrate and the optical multilayer.

Film separation of the glass member with an optical multilayer in each of Examples and Comparative Example was evaluated as follows. First, on the film surface of the optical multilayer formed on the glass substrate, by a conventional glass cutter, several linear scars which reached the glass substrate, having a length of about 10 mm, were formed at an interval of about 2 mm in a grid pattern. Then, an adhesive tape (width: 12 to 19 mm) as specified by JIS Z1522 was bonded to the scars in a grid pattern and rapidly pulled in a vertical direction to the film surface of the optical multilayer, whereupon formation of film separation of the optical multilayer was observed.

The evaluation standards are as follows. ◯: no film separation observed at all, ◯ to Δ: linear film separation resulting from a part of the scars in a grid pattern slightly observed, Δ: planar film separation resulting from a part of the scars in a grid pattern partially observed, and x: planar film separation observed on the most part of the tape surface.

### Example 1

As the adhesion-strengthening layer, a three-layer film (total thickness: 0.27 μm) consisting of a film (67 nm) of a mixture of aluminum oxide (Al₂O₃) and zirconium oxide (ZrO₂), a zirconium oxide (ZrO₂) film (121 nm), and a magnesium fluoride (MgF₂) film (85 nm) from the glass substrate side was formed on one main surface of the glass substrate by a deposition method without using ion-beam assist. Then, the above-described optical multilayer was formed. The adhesion-strengthening layer also functioned as an antireflection film, and had no influence over the optical properties of the optical multilayer.

### Example 2

As the adhesion-strengthening layer, a film (120 nm) of a mixture of aluminum oxide (Al₂O₃) and zirconium oxide (ZrO₂) from the glass substrate side, was formed on one main surface of the glass substrate by a deposition method without using ion-beam assist. Then, the above-described optical multilayer was formed. At the time when the adhesion-strengthening layer was formed on the glass substrate, the glass substrate temperature was 300° C., the degree of vacuum in the deposition apparatus was 3.6×10⁻² Pa, and 40 sccm of an argon gas was introduced.

### Example 3

As the adhesion-strengthening layer, an alternate film having two-layer basic layers having a silicon dioxide (SiO₂) film and a titanium oxide (TiO₂) film laminated in this order from the glass substrate side, repeatedly laminated (the number of the two-layer basic layers: 7 layers, total thickness: 0.30 μm) was formed on one main surface of the glass substrate by a deposition method without using ion-beam assist. Then, the above-described optical multilayer was formed.

### Example 4

As the adhesion-strengthening layer, a single layer film (thickness: 240 nm) of silicon oxide (SiO₂) was formed on one main surface of the glass substrate by a deposition method without using ion-beam assist. Then, the above-described optical multilayer was formed.

### Example 5

As the adhesion-strengthening layer, a single layer film (thickness: 60 nm) of titanium oxide (TiO₂) was formed on one main surface of the glass substrate by a deposition method without using ion-beam assist. Then, the above-described optical multilayer was formed.

### Example 6

As the adhesion-strengthening layer, a single layer film (thickness: 240 nm) of lanthanum titanium oxide (La₂Ti₂O₇) was formed on one main surface of the glass substrate by a deposition method without using ion-beam assist. Then, the above-described optical multilayer was formed.

### Comparative Example 1

Without forming the adhesion-strengthening layer, the above-described optical multilayer was formed directly on the glass substrate.

Results of evaluation of film separation in Examples and Comparative Example are shown in Table 1. As evident from this Table, by the adhesion-strengthening layer interposed between the glass substrate and the optical multilayer, formed by a deposition method without using ion-beam assist, the adhesion of the optical multilayer is improved, and film separation can be suppressed.

TABLE 1

| | Constitution of adhesion- | Evaluation of film |
|---|---|---|
| | strengthening layer | separation |
| Example 1 | Al₂O₃•ZrO₂/ZrO₂/MgF₂ | ◯ |
| Example 2 | Al₂O₃•ZrO₂ | ◯ to Δ |
| Example 3 | TiO₂/SiO₂ | ◯ to Δ |
| Example 4 | SiO₂ | Δ |
| Example 5 | TiO₂ | ◯ to Δ |
| Example 6 | La₂Ti₂O₇ | ◯ |
| Comparative | Not used | X |
| Example 1 | | |

### Example 7

Using the same glass member with an optical multilayer as in Example 1, the same adhesion-strengthening layer as in Example 1 was formed on the other surface. Then, as the optical multilayer, an infrared-shielding film (an alternate film having three-layer basic layers each having a titanium oxide (TiO₂) film, a silicon oxide (SiO₂) film and a tantalum oxide (Ta₂O₅) layer laminated in this order, repeatedly laminated (number of the three-layer basic layers: 68 layers, total thickness: 6 μm)) was formed on the adhesion-strengthening layer by an ion-beam assisted deposition method. Film separation was evaluated with respect to the optical multilayers formed on both sides of the glass substrate. As a result, film separation of the optical multilayer was not confirmed on both surfaces, and the evaluation result was 0.

### Example 8

As the adhesion-strengthening layer, a film (75 nm) of a mixture of aluminum oxide (Al₂O₃) and zirconium oxide (ZrO₂) was formed on one main surface of the glass substrate by a deposition method without using ion-beam assist. At the time when the adhesion-strengthening layer was formed on the glass substrate, the glass substrate temperature was 128° C., the degree of vacuum in the deposition apparatus was 8.0×10⁻³ Pa, and 30 sccm of an oxygen gas was introduced. Then, the above-described optical multilayer (infrared-shielding film (an alternate film having three-layer basic layers each having a titanium oxide (TiO₂) film, a silicon oxide (SiO₂) film and a tantalum oxide (Ta₂O₅) film laminated in this order, repeatedly laminated (number of the three-layer basic layers: 80 layers, total thickness: 4 μm))) was formed. In Example 8, a favorable result of evaluation of film separation was obtained as compared with Example 2, and the evaluation result was ◯. This is considered to be because in the step of forming the adhesion-strengthening layer, deposition was carried out at a temperature of the glass substrate 1 lower than that in Example 2, whereby a film having a further lower hardness and being more fragile was formed as compared with the adhesion-strengthening layer in Example 2, and accordingly the adhesion between the glass substrate and the adhesion-strengthening layer was firmer.

Then, the adhesion-strengthening layer in Example 8 was formed on each of the glass substrates in Examples 1 to 17 as shown in Tables 2 and 3, and as the optical multilayer, an infrared-shielding film (an alternate film having three-layer basic layers each having a titanium oxide (TiO₂) film, a silicon oxide (SiO₂) film and a tantalum oxide (Ta₂O₅) film laminated in this order, repeatedly laminated (number of the three-layer basic layers: 80 layers, total thickness: 4 μm)) was formed on one main surface of each glass substrate by an ion-beam assisted deposition method. Each glass substrate was prepared as follows. Glass raw materials were weighed and mixed so as to achieve the glass composition (cation %, anion %) as identified in each Table, and the mixture was put in a platinum crucible having an internal capacity of about 300 cc, and the glass materials were melted at 850° C. for from 2 to 80 hours. In Comparative Example, the glass raw materials were melted at 850° C. for one hour. Then, the molten glass was fined and stirred and then cast into a rectangular mold having a size of 50 mm×50 mm×20 mm in height, preheated to about 300° C. to about 500° C., and annealed at about 1° C./min to obtain a glass substrate. The main surfaces of the glass substrate were optically polished, and on the main surface, the above-described adhesion-strengthening layer and optical multilayer were formed. The above-described film separation was evaluated with respect to the optical multilayer formed on the glass substrate. As a result, film separation of the optical multilayer was not confirmed on any of the glass substrates, and the evaluation results were ◯.

From the above results, it is considered that by the glass substrate and the adhesion-strengthening layer containing an Al component, the adhesion between them was increased, and favorable results regarding film separation were obtained.

TABLE 2

| cation %, | | | | | | | | | |
|---|---|---|---|---|---|---|---|---|---|
| anion % | Ex. 1 | Ex. 2 | Ex. 3 | Ex. 4 | Ex. 5 | Ex. 6 | Ex. 7 | Ex. 8 | Ex. 9 |
| P⁵⁺ | 43.4 | 42.8 | 32.5 | 35.2 | 27.5 | 47.9 | 44.0 | 25.4 | 38.5 |
| Al³⁺ | 9.9 | 10.2 | 17.7 | 16.9 | 12.2 | 6.0 | 2.2 | 18.2 | 6.7 |
| Li⁺ | 23.8 | 21.5 | 16.3 | 17.6 | 7.6 | 6.0 | 1.1 | 12.1 | 35.6 |
| Na⁺ | 0.0 | 3.0 | 0.0 | 8.8 | 12.6 | 10.0 | 26.4 | 10.1 | 0.0 |
| K⁺ | 0.0 | 0.0 | 11.6 | 0.0 | 0.0 | 6.0 | 1.1 | 14.2 | 0.0 |
| R⁺ | 23.8 | 24.5 | 27.9 | 26.4 | 20.2 | 22.0 | 28.6 | 36.4 | 35.6 |
| Mg²⁺ | 5.9 | 6.1 | 7.0 | 7.5 | 10.8 | 8.5 | 6.5 | 6.0 | 1.0 |
| Ca²⁺ | 5.9 | 6.1 | 4.5 | 3.8 | 5.4 | 12.0 | 6.5 | 6.0 | 5.7 |
| Sr²⁺ | 4.0 | 4.1 | 4.6 | 5.0 | 7.2 | 1.2 | 4.4 | 4.0 | 3.8 |
| Ba²⁺ | 3.0 | 3.1 | 3.5 | 3.8 | 15.2 | 0.0 | 3.3 | 3.0 | 2.9 |
| Zn²⁺ | 0.0 | 0.0 | 0.0 | 0.0 | 0.0 | 0.0 | 0.0 | 0.0 | 1.9 |
| R²⁺ | 18.8 | 19.4 | 19.6 | 20.1 | 38.6 | 21.7 | 20.7 | 19.0 | 15.3 |
| Cu²⁺ | 4.1 | 3.1 | 2.3 | 1.1 | 1.5 | 2.4 | 4.5 | 1.0 | 3.9 |
| Sb³⁺ | 0.0 | 0.0 | 0.0 | 0.3 | 0.0 | 0.0 | 0.0 | 0.0 | 0.0 |
| O²⁻ | 85.0 | 92.0 | 55.0 | 65.0 | 63.0 | 85.0 | 85.0 | 48.0 | 76.0 |
| F⁻ | 15.0 | 8.0 | 45.0 | 35.0 | 37.0 | 15.0 | 15.0 | 52.0 | 24.0 |

TABLE 3

| cation %, | | | | | | | | |
|---|---|---|---|---|---|---|---|---|
| anion % | Ex. 10 | Ex. 11 | Ex. 12 | Ex. 13 | Ex. 14 | Ex. 15 | Ex. 16 | Ex. 17 |
| P⁵⁺ | 38.8 | 39.4 | 42.3 | 32.7 | 34.0 | 36.8 | 37.2 | 44.2 |
| Al³⁺ | 4.9 | 4.8 | 6.0 | 4.7 | 4.9 | 5.3 | 5.3 | 12.6 |
| Li⁺ | 0.0 | 0.0 | 6.0 | 1.9 | 1.9 | 2.1 | 2.1 | 2.5 |
| Na⁺ | 35.9 | 0.0 | 2.4 | 1.9 | 1.9 | 2.1 | 2.1 | 2.5 |
| K⁺ | 0.0 | 35.6 | 2.4 | 11.2 | 11.7 | 12.6 | 12.8 | 17.7 |
| R⁺ | 35.9 | 35.6 | 10.8 | 15.0 | 15.5 | 16.8 | 17.0 | 22.7 |
| Mg²⁺ | 1.0 | 1.0 | 1.2 | 0.9 | 1.0 | 1.1 | 1.1 | 2.5 |
| Ca²⁺ | 5.8 | 5.7 | 14.4 | 28.0 | 1.9 | 2.1 | 2.1 | 1.3 |
| Sr²⁺ | 3.8 | 3.8 | 7.2 | 5.6 | 29.1 | 0.0 | 0.0 | 3.8 |
| Ba²⁺ | 2.9 | 2.9 | 9.6 | 7.5 | 7.8 | 31.6 | 0.5 | 3.8 |
| Zn²⁺ | 1.9 | 1.9 | 2.5 | 1.9 | 1.9 | 2.1 | 31.9 | 0.0 |
| R²⁺ | 15.4 | 15.3 | 34.9 | 43.9 | 41.7 | 36.9 | 35.6 | 11.4 |
| Cu²⁺ | 4.9 | 4.9 | 6.0 | 3.7 | 3.9 | 4.2 | 4.3 | 8.8 |
| Sb³⁺ | 0.1 | 0.0 | 0.0 | 0.0 | 0.0 | 0.0 | 0.6 | 0.3 |
| O²⁻ | 72.0 | 70.0 | 73.0 | 69.0 | 67.0 | 68.0 | 75.0 | 74.0 |
| F⁻ | 28.0 | 30.0 | 27.0 | 31.0 | 33.0 | 32.0 | 25.0 | 26.0 |

### INDUSTRIAL APPLICABILITY

With respect to the glass member with an optical multilayer and the near infrared cut filter glass of the present invention, the adhesion between the glass substrate and the optical multilayer is high, and film separation is suppressed when the glass member with an optical multilayer is cut.

This application is a continuation of PCT Application No. PCT/JP2012/080228, filed on Nov. 21, 2012, which is based upon and claims the benefit of priority from Japanese Patent Application No. 2011-253916 filed on Nov. 21, 2011. The contents of those applications are incorporated herein by reference in their entireties.

### REFERENCE SYMBOLS

1: Glass substrate
2: Adhesion-strengthening layer
3: Optical multilayer
4: Optical multilayer
10, 20: Glass member

What is claimed is:

1. A glass member with an optical multilayer, comprising a fluorophosphate glass substrate and an optical multilayer formed on the substrate, wherein an adhesion-strengthening layer consisting of one or more layers, which improves the adhesion of the optical multilayer to the fluorophosphate glass substrate, is formed between the fluorophosphate glass substrate and the optical multilayer; and
the optical multilayer is formed by a sputtering method or an ion-beam assisted deposition method, and the adhesion-strengthening layer is formed by a deposition method without using ion-beam assist.

2. The glass member with an optical multilayer according to claim 1, wherein the adhesion-strengthening layer has an oxide film made of a material selected from silicon oxide (SiO₂), titanium oxide (TiO₂), lanthanum titanium oxide (La₂Ti₂O₇), aluminum oxide (Al₂O₃), and a mixture of aluminum oxide (Al₂O₃) and zirconium oxide (ZrO₂), as a first layer on the fluorophosphate glass substrate side.

3. The glass member with an optical multilayer according to claim 2, wherein the adhesion-strengthening layer has an oxide film having a refractive index of at most 1.68, as a first layer on the fluorophosphate glass substrate side.

4. The glass member with an optical multilayer according to claim 2, wherein the adhesion-strengthening layer has, in addition to the oxide film, a magnesium fluoride (MgF₂) film as a layer other than the first layer on the fluorophosphate glass substrate side.

5. The glass member with an optical multilayer according to claim 1, wherein the adhesion-strengthening layer has a three-layer structure having a film of a mixture of aluminum oxide (Al₂O₃) and zirconium oxide (ZrO₂), a zirconium oxide (ZrO₂) film and a magnesium fluoride (MgF₂) film laminated in this order from the glass substrate side.

6. The glass member with an optical multilayer according to claim 1, wherein the optical multilayer consists of 15 or more layers, or has a total thickness of at least 1 μm.

7. The glass member with an optical multilayer according to claim 1, wherein the adhesion-strengthening layer has substantially no influence over optical properties of the optical multilayer.

8. The glass member with an optical multilayer according to claim 1, wherein the adhesion-strengthening layer constitutes a part of the optical multilayer.

9. The glass member with an optical multilayer according to claim 1, wherein the optical multilayer is at least one member of an antireflection film, an infrared-shielding film, an ultraviolet-shielding film and an ultraviolet- and infrared-shielding film.

10. The glass member with an optical multilayer according to claim 1, wherein the first layer of the adhesion-strengthening layer on the fluorophosphate glass substrate side contains an Al component, and the fluorophosphate glass substrate contains as essential components P⁵⁺, Al³⁺, F⁻ and Cu²⁺.

11. A near infrared cut filter glass, comprising the glass member with an optical multilayer as defined in claim 1.
